(19) United States
(12) Patent Application Publication
(10) Pub. No.: US 2008/0258072 A1
(43) Pub. Date: Oct. 23, 2008

(54) Detector for Ionizing Radiation

(76) Inventors: Bert Junno, Malmo (SE); Jan Stalemark, Stockholm (SE)

Correspondence Address: LADAS & PARRY LLP, 224 SOUTH MICHIGAN AVENUE, SUITE 1600, CHICAGO, IL, 60604, US

(21) Appl. No.: 11/660,885

(22) PCT Filed: Aug. 23, 2005
(86) PCT No.: PCT/SE05/01228

§ 371 Date: Mar. 10, 2008

(30) Foreign Application Priority Data
Aug. 23, 2004 (SE) 0402074-9
Mar. 3, 2005 (SE) 0500490-8

(51) Int. Cl. H01J 47/00

(52) U.S. Cl. 250/389

(57) ABSTRACT

A detector for detecting ionising radiation having at least one detector arranged to be connected to a read-out arrangement for the reading-out and the evaluation of a signal from the detector. The detector has a carrier material and a layer having an active detector material applied to the carrier material, which active detector material is arranged, in the event of its receiving incident ionising radiation that is incident upon the layer, to give rise to ionisation in the active detector material in the layer. An electrical field is applied across the layer, whereby the ionisation gives rise to an electric current. The read-out arrangement is arranged to detect such that it can in this way detect the incident ionising radiation. The active detector material in the layer contains ZnO to such an extent that ionising radiation gives rise to a detectable electric current.

The present invention concerns a detector for ionising radiation.

Examples of such radiation are X-rays used in investigations in which X-ray detectors can be used to record in an electronic manner an image of an object or a living creature. Another example are detectors used to detect gamma radiation used in for example medical materials science or security applications. However, the present detector can be used in order to detect all types of ionising radiation. Furthermore, the present detector can be used both in medical applications and in industrial applications. Within the medical field, detection can be carried out in connection with, for example, the use of gamma radiation to treat a disease, or for the use of X-rays. Within the industrial field, detection of radiation can be carried out in connection with, for example, investigation of objects within microelectronics, nanotechnology, etc.

Thus, the present invention is not to be regarded as being limited to any one particular field of use.

The Prior Art

Different designs of digital detectors of ionising radiation are available. Some of these are based on amorphous semiconductors that create charges at the surface layer when exposed. A detector plate with a layer of amorphous semiconductor is read in a read-out arrangement, whereby an image of an object is obtained.

Recently, digital detectors have also been developed. These are based on different technical solutions. One type of detectors has silicon in the detector. X-rays or gamma photons can in this way be directly collected in the silicon-based detector. The silicon-based detectors can either be of plate-type, i.e. a plane area of silicon with image pixels, or they can be built up from pixels comprising rods of silicon that protrude from a silicon substrate.

Another type of detectors is based on a type of detector that comprises a gas avalanche detector, in which a noble gas is used as an amplifier. A cloud of electrons is in this manner generated that can be detected by detector plates with electrodes of, for example, metal applied to a carrier.

Different types of semiconductor detectors are available for the detection of ionising radiation, such as detectors containing germanium, silicon, CdTe and HgI₂. Detectors of scintillation type can comprise an active material comprising NaI, CsI, BGO, BaF₂, plastic or fibres.

Known detectors suffer principally from the disadvantage that they are expensive. Another disadvantage is that they give rise to a relatively slow recording of the input radiation.

The present invention eliminates these disadvantages.

The costs of digital detectors are reduced through the present invention, while the performance of the detectors is at the same timeincreased.

The present invention thus relates to a detector for detecting ionising radiation comprising at least one detector arranged to be connected to a read-out arrangement for the reading and the evaluation of a signal from the detector, which detector comprises a carrier material and a layer comprising an active detector material applied to this carrier material, which active detector material is arranged, in the event of its receiving ionising radiation that is incident upon the said layer, to give rise to ionisation in the said active detector material in the said layer, where an electrical field is applied across the said layer, whereby the said ionisation gives rise to an electric current, which read-out arrangement is arranged to detect such that it can in this way detect the said incident ionising radiation, and it is characterised in that the said active detector material in the said layer contains ZnO to such an extent that ionising radiation gives rise to a detectable electric current.

The present invention is described in more detail below, partly in association with an embodiment of the invention shown on the attached drawings, where

FIG. 1a shows schematically a cross-section of a detector according to a first embodiment of the present invention;

FIG. 1b and 1c illustrate the principle according to which the present invention operates;

FIG. 2 shows a detector according to a second embodiment according to the invention;

FIG. 3 shows a detector according to a third embodiment of the invention; and

FIG. 4 shows an embodiment of the invention with two levels of detectors.

The active material zinc oxide makes possible low doses of radiation and gives rapid recording, and this means that also so called moving images formed by X-rays can be generated. The invention comprises a detector or a CCD (a Charge Coupled Device), in which the detector material consists of zinc oxide in an amorphous, crystalline or nanocrystalline form, either in a pure form or doped with a dopant. The zinc oxide may be present in a p-doped, n-doped or intrinsic form. The zinc oxide is subsequently deposited onto a carrier material. This may be of various properties such as glass, quartz crystal, ceramic, polymeric, sapphire, silicon or similar. The carrier material has read-out electrodes integrated into the surface layer or in the carrier material. It is, however, important to point out that it is the pure or doped zinc oxide that is the active material for the detection of photons. Integrated with the carrier material or mounted onto the carrier material there are electronic circuits for amplification, threshold detection, signal processing and digitalisation. The zinc oxide may either be applied to one large region, which forms the complete detector, or it may be applied to subregions, which are subsequently assembled together to form a detector unit. The active material zinc oxide can be adapted to different wavelengths. Furthermore, the active material zinc oxide gives a constant response in the relevant wavelength range, and this facilitates the design of the electronic circuits used for reading-out and for detection.

### BRIEF DESCRIPTION OF THE DRAWINGS

The invention will be described below with schematic drawings, where FIG. 1a shows a detector for ionising radiation, where the active material zinc oxide has been applied to the readout chip with its layer of conductor. FIGS. 1b and 1c illustrate the principle according to which the present invention functions.

FIG. 2 shows how the zinc oxide has been applied to a circuit board, which then has connections to electronic circuits for reading-out and for detection. FIG. 3 shows how the active material has been applied to a carrier substrate, which has electric connections such that it can be connected to electronic circuits for reading-out and for detection with the aid of flip-chip technology. The connection can also be connected to other contact elements such as, for example, conducting rubber elements. FIG. 4 shows a technological solution in which the detector material (ZnO) has been applied to the substrate, which consists of a circuit board of a polymer material, ceramic, silicon or similar. Furthermore, a second layer of active material has been applied. This makes it possible to measure the angle of incidence of the ionising radiation.

In addition, the energy level of the incident photons can be measured.

### DETAILED DESCRIPTION

The invention comprises a detector or a CCD (Charge Coupled Device), in which the detector material consists of zinc oxide in amorphous, crystalline or nanocrystalline form, either in pure form or doped with a dopant. The zinc oxide may be p-doped, n-doped or it may have its intrinsic form.

FIG. 1a shows a detector for ionising radiation, such as X-rays or gamma rays 3, where the active material zinc oxide 4 has been applied to a read-out chip 7 provided with a conducting layer 6. A dielectric material 5 is present between the conductors in the conducting layer 6. A top electrode 1 is applied above the active material 4.

FIG. 1b shows a detector with, when traversed from the top downwards, a top electrode, a dielectric layer, the active detector material, a conducting layer with electrical conductors surrounded by a dielectric material, and a carrier layer. A Schottky contact may be formed in the top electrode instead of a dielectric layer under the top electrode. The lower dielectric material can, in a similar manner, be replaced by a Schottky contact. Photons that are incident on and stopped by the detector volume of ZnO are converted into an electron-hole pair, which in turn relax their excess energy in such a manner that further electron-hole pairs are formed. The free charge-carriers are subsequently accelerated in an applied electric field and the electrons collect in limited and isolated read-out islands of metal, which read-out islands are connected to read-out contacts. An electric field is applied between the top electrode and the read-out islands and this field thus lies principally across the detector volume characterised by a capacitance Cd, see FIG. 1c. This capacitance Cd is significantly smaller than a capacitance Cs between the read-out contacts and earth. A signal is extracted via a conductor from between the capacitance Cs and earth to the read-out electronics. According to one preferred embodiment, the said active material comprises p-doped ZnO with up to 5% nitrogen (N), arsenic (As) or phosphorus (P).

According to another preferred embodiment, the said active material comprises n-doped ZnO with up to 5% aluminium (Al), indium (In) or gallium (Ga).

The conducting layer 6, located under the layer 4 of active detector material, comprises according to one preferred embodiment an electrically conducting layer comprising one or more of the metals titanium (Ti), aluminium (Al), platinum (Pt), gold (Au) and silver (Ag).

An electrically conducting layer I in the form of a top electrode 1 is located above the layer of an active detector material, which comprises one or several of the metals titanium (Ti), aluminium (Al), platinum (Pt), gold (Au) or silver (Ag).

The said active detector material is arranged to supply the said detectable electrical current for incident electromagnetic radiation with an energy level in the interval 1 KeV and 20 MeV.

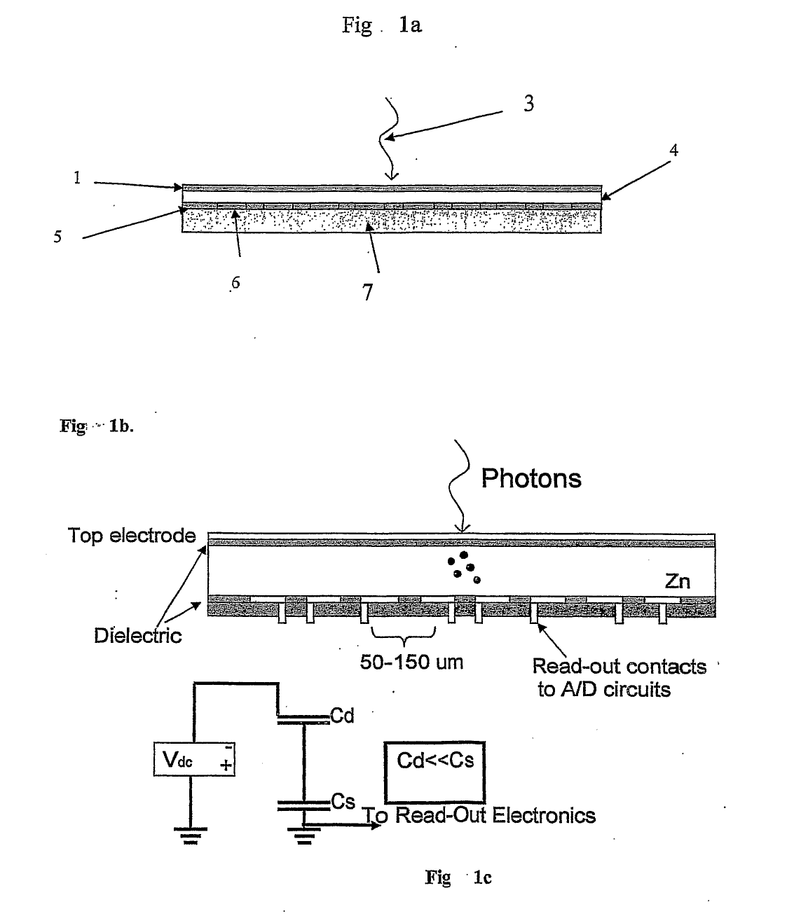

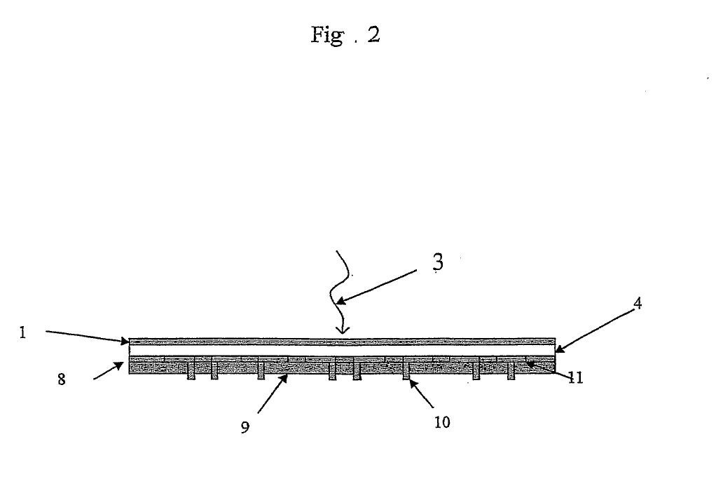

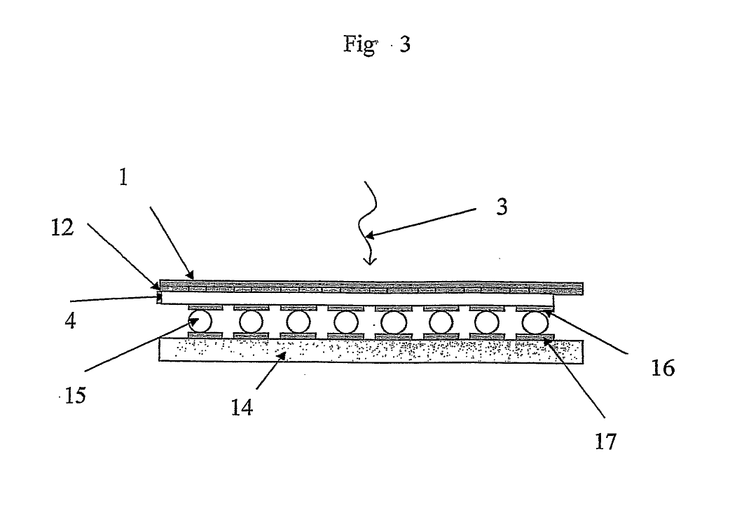

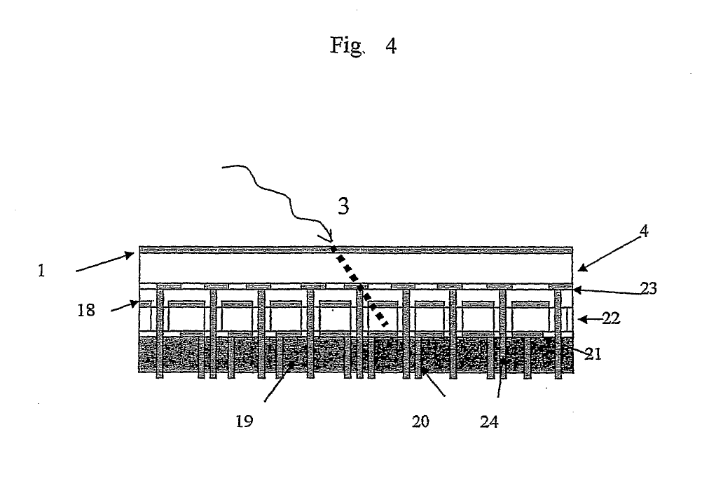

FIG. 2 shows a detector, according to a second embodiment, for ionising radiation 3. According to this embodiment, the active material zinc oxide 4 has been applied onto a conducting layer 11, that lies on a circuit board 9, for example, a printed circuit board. The conducting layer comprises electrical conductors with a dielectric medium 8 between the conductors. The conductors have electrical connections 10 to suitable known electronic circuits for the present type of detector, not shown in the drawing, for reading-out and for detection. The top electrode 1 is applied above the active material 4. This design of detector ensures that it is possible to spread out the connections 10 such that mounting onto the read-out and detection chip is facilitated. Efficient mounting methods such as, for example, wire bonding can then be used.

FIG. 3 shows a detector for ionising radiation 3 according to a third embodiment. The active material zinc oxide 4 has been applied to a carrier substrate 12, which has electrical connections 16 such that it can be connected to read-out islands 17 on the electronic circuits 14 for read-out and detection with the aid of flip-chip technology with BGA (Ball Grid Array) technology. The connection may also be made using other contact elements such as, for example, conducting rubber elements. A circuit board or substrate 12 with a conducting layer has been applied on top of the active material 4, as has been described above. The top electrode 1 has been applied on top of the circuit board or substrate 12.

FIG. 4 shows a detector for ionising radiation according to a fourth embodiment.

According to this embodiment, a second equivalent detector arrangement is arranged under a first detector arrangement comprising a top electrode, an active layer and an electrically conducting layer, whereby the incident radiation is incident first upon the upper active material and subsequently upon the lower active material, where a read-out circuit is present for each layer of active material.

The active material zinc oxide 4 is applied to a carrier substrate 23 with read-out islands. The carrier substrate 23, with the read-out islands, consists of a circuit board of polymer material, ceramic, silicon or similar material.

Furthermore, a second layer 22 of active material including a top electrode 18 is applied under the carrier substrate 23. A carrier substrate 19 is present under the second active layer, with read-out islands, which also consists of a circuit board of polymer material, ceramic, silicon or similar material.

The lower active layer 22 is sectioned into pixels.

According to one preferred embodiment, in the case in which several detectors are placed onto the same substrate, a dielectric material is placed between different parts of the said electrically conducting material under the layer of the active material in order to form separated electrical conductors in the electrically conducting layer.

FIG. 4 shows electrical connections, known as “vias”, 20 and 24, drawn through the relevant substrate in order to be able to provide connections to the read-out and detection chip.

This design makes possible the measurement of the angle of incidence of the incident radiation 3. The angle of incidence of the photons is determined with the aid of the read-out electronic circuits, which interact both with the read-out islands in the detector plane in which detection takes place and with islands in other planes. With exact time determination of events down to a precision of microseconds or with shorter time intervals, the cloud of electrons that so is created by one photon can be detected in several layers with at least two different read-out islands in different planes that interact. The angle of incidence can be calculated from this information arising from single-photon events.

Furthermore, the energy level of the incident photons can be measured. The energy level is determined through two or more layers of the detector electrodes discriminating between radiation with different energies. Photons that have been able to penetrate the first detector volume with a maximum energy E1 are detected in an upper layer of detector material. Photons with an energy that is greater than E1 are detected in an unerlying layer. If more than two detector layers are used, radiation from several energy intervals can be discriminated and used to provide an X-ray image with an artificial “colour depth”.

Three-dimensional and real-colour X-ray images can in this way be realised.

It is preferred according to all embodiments that what are known as “TFTs” (Thin Film Transistors) are formed either in or on the said electrically conducting layer in order to read the active detector material.

According to an alternative preferred embodiment, what are known as “CCD elements” (Charged Coupled Device elements) are formed either in or on the said electrically conducting layer in order to read the active detector material.

According to a further alternative preferred embodiment, what are known as “ROICs” (Read Out Integrated Circuits) are formed either in or on the said electrically conducting layer in order to read the active detector material.

According to all embodiments described above, the thickness of the active layer is between 10 and 10,000 micrometers.

According to one preferred embodiment, the dimensions of the detector in its own plane are up to 1×1 meter.

A number of embodiments have been described above. It is, however, apparent that a detector according to the present invention can be modified by one skilled in the arts with respect to the design of the detector layer in its own plane and with respect to the design of the conducting layers.

The present invention for this reason is not to be regarded as limited to the embodiments specified above, but can be varied within the scope of the attached claims.

1-16. (canceled)

17. A detector for detecting ionising radiation of X-rays and gamma rays comprising at least one detector arranged to be connected to a read-out arrangement for the reading-out and the evaluation of a signal from the detector, which detector comprises a carrier material and a layer comprising an active detector material applied to the carrier material, which active detector material is arranged, in the event of its receiving ionising radiation that is incident upon the said layer, to give rise to ionisation in said active detector material in said layer, where an electrical field is applied across said layer, whereby said ionisation gives rise to an electric current, which said read-out arrangement is arranged to detect such that it can in this way detect said incident ionising radiation, wherein the said active detector material in said layer contains ZnO to such an extent that ionising radiation gives rise to a detectable electric current.

18. A detector according to claim 17, wherein said active detector material comprises ZnO in amorphous, crystalline or nanocrystalline form.

19. A detector according to claim 17, wherein said active material comprises p-doped ZnO with up to 5% nitrogen (N), arsenic (As) or phosphorus (P).

20. A detector according to claim 17, wherein said active material comprises n-doped ZnO with up to 5% aluminium (Al), indium (In) or gallium (Ga).

21. A detector according to claim 17, wherein said active material comprises ZnO in its intrinsic form.

22. A detector according to claim 17, an electrically conducting layer comprising one or more of the metals titanium (Ti), aluminum (Al), platinum (Pt), gold (Au) and silver (Ag) is present under the layer of active detector material.

23. A detector according to claim 17 wherein an electrically conducting layer in the form of a top electrode comprising one or more of the metals titanium (Ti), aluminium (Al), platinum (Pt), gold (Au) and silver (Ag) is present above the layer of active detector material.

24. A detector according to claim 17 wherein the detector with said three layers, namely the active layer and a layer above and below the active layer, is built up on a substrate of polymer material, ceramic material or a silicon material.

25. A detector according to claim 24, wherein in the case in which several detectors are located on the same substrate, a dialectric material is located between different parts of said electrically conducting material under the layer of the active material in order to form separated electrical conductors in the electrically conducting layer.

26. A detector according to claim 17, wherein what are known as “TFTs” (Thin Film Transistors) are formed in or on the said electrically conducting layer in order to read out the active detector material.

27. A detector according to claim 17, wherein what are known as “CCD elements” (Charge Coupled Device elements) are formed in or on said electrically conducting layer in order to read out the active detector material.

28. A detector according to claim 17, wherein what are known as “ROICs” (Read Out Integrated Circuits) are formed in or on said electrically conducting layer in order to read out a signal from the active detector material.

29. A detector according to claim 17, wherein the thickness of the active layer is between 10 and 10,000 micrometers.

30. A detector according to claim 17, wherein the dimensions of the detector in its own plane are up to 1×1 meter.

31. A detector according to claim 17, wherein a second corresponding detector arrangement is arranged under a first detector arrangement comprising a top electrode, an active layer and an electrically conducting layer, whereby incident radiation is incident first upon the upper active material and subsequently upon the lower active material and in that a read-out circuit is present for each layer of active material.
